(19) United States
(12) Patent Application Publication
(10) Pub. No.: US 2010/0055588 A1
(43) Pub. Date: Mar. 4, 2010

(54) CHARGE TRANSPORT LAYER HAVING HIGH MOBILITY TRANSPORT MOLECULE MIXTURE

(75) Inventors: Nancy Belknap, Rochester, NY (US); John F. Yanus, Webster, NY (US); Helen R. Cherniack, Rochester, NY (US); David M. Skinner, Rochester, NY (US); Kent J. Evans, Lima, NY (US); Edward F. Grabowski, Webster, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/199,666

(22) Filed: Aug. 27, 2008

(51) Int. Cl. G03G 15/02

(52) U.S. Cl. 430/58.8

(57) ABSTRACT

The presently disclosed embodiments relate generally to layers that are useful in imaging apparatus members and components, for use in electrostatographic, including digital, apparatuses. More particularly, the embodiments pertain to an improved electrostatographic imaging member having a specific mixture of high mobility molecules in the charge transport layer which exhibits reduced propensity for crystallization while maintaining or improving electrical performance.

### BACKGROUND

The presently disclosed embodiments relate generally to layers that are useful in imaging apparatus members and components, for use in electrostatographic, including digital, apparatuses. More particularly, the embodiments pertain to an improved electrostatographic imaging member having a specific mixture of high mobility molecules in the charge transport layer which exhibits reduced propensity for crystallization while maintaining or improving electrical performance.

Electrophotographic imaging members, e.g., photoreceptors, photoconductors, and the like, typically include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment moves under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

Typical multilayered photoreceptors or imaging members have at least two layers, and may include a substrate, a conductive layer, an optional undercoat layer (sometimes referred to as a “charge blocking layer” or “hole blocking layer”), an optional adhesive layer, a photogenerating layer (sometimes referred to as a “charge generation layer,” “charge generating layer,” or “charge generator layer”), a charge transport layer, and an optional overcoating layer in either a flexible belt form or a rigid drum configuration. In the multilayer configuration, the active layers of the photoreceptor are the charge generation layer (CGL) and the charge transport layer (CTL). Enhancement of charge transport across these layers provides better photoreceptor performance. Multilayered flexible photoreceptor members may include an anti-curl layer on the backside of the substrate, opposite to the side of the electrically active layers, to render the desired photoreceptor flatness.

Incorporation of high mobility charge transport molecules, such as for example, triphenyl amine, N,N,N′,N′-tetra-p-tolyl-1,1′-biphenyl-4,4′-diamine (TM-TPD) and N,N′-diphenyl-N,N′-bis(3-methyl-phenyl)-(1,1′-biphenyl)-4,4′-diamine (TPD), are known to be useful for enhancing charge transport across the CTL. However, TM-TPD has a propensity to crystallize in the CTL coating-for drum photoreceptors, crystallization occurs after coating and for belt photoreceptors, crystallization occurs in the CTL coating suspension prior to coating-rendering the photoreceptor unusable. Crystallization in the solution increases cost driven by the shortened pot-life of the solution or by requiring additional solution processing.

Thus, there is a need for transport molecules that can provide enhanced charge transport across the CTL but without the problems such as that described above.

The term “photoreceptor” or “photoconductor” is generally used interchangeably with the terms “imaging member.” The term “electrostatographic” includes “electrophotographic” and “xerographic.” The terms “charge transport molecule” are generally used interchangeably with the terms “hole transport molecule.”

### SUMMARY

According to aspects illustrated herein, there is an imaging member comprising a substrate, an undercoat layer disposed on the substrate, a charge generation layer disposed on the undercoat layer, wherein the charge generation layer comprises a phthalocyanine pigment, a charge transport layer disposed on the charge generation layer, wherein the charge transport layer comprises a first transport molecule and a second transport molecule, the first transport molecule being

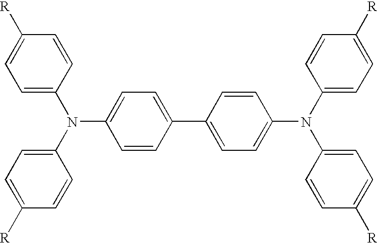

wherein R is an alkyl isomer, and the second transport molecule being selected from the group consisting of

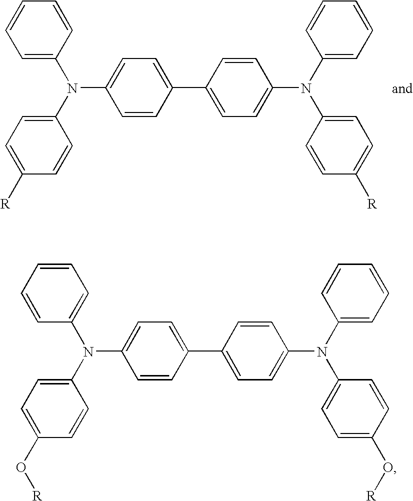

wherein R is an alkyl isomer, and an optional overcoat layer.

Another embodiment provides an imaging member comprising a substrate, an undercoat layer disposed on the substrate, a charge generation layer disposed on the undercoat layer, wherein the charge generation layer comprises a phthalocyanine pigment, a dual layer charge transport layer disposed on the charge generation layer, wherein the dual layer charge transport layer comprises a first transport molecule and a second transport molecule, the first transport molecule being TM-TPD and the second transport molecule being selected from the group consisting of p-TPD, p-MeOTPD,

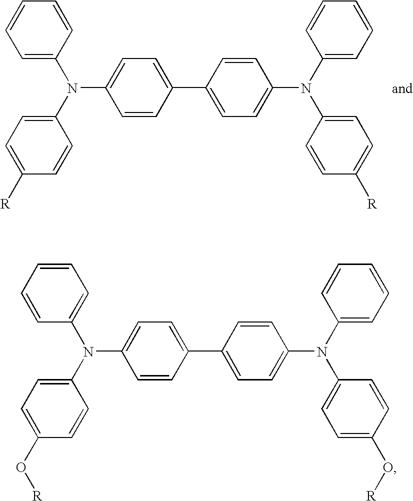

wherein R is an alkyl isomer; and an optional overcoat layer.

Yet another embodiment, there is an imaging member comprising a substrate, an undercoat layer disposed on the substrate, a charge generation layer disposed on the undercoat layer, wherein the charge generation layer comprises a phthalocyanine pigment, a charge transport layer disposed on the charge generation layer, wherein the charge transport layer comprises a first transport molecule and a second transport molecule, the first transport molecule being TM-TPD and the second transport molecule being p-TPD or p-MeOTPD, and an optional overcoat layer.

### BRIEF DESCRIPTION OF THE DRAWINGS

For a better understanding, reference may be made to the accompanying figures.

FIG. 1 is a cross-sectional view of an imaging member in a drum configuration according to the present embodiments; and

FIG. 2 is a cross-sectional view of an imaging member in a belt configuration according to the present embodiments.

### DETAILED DESCRIPTION

In the following description, reference is made to the accompanying drawings, which form a part hereof and which illustrate several embodiments. It is understood that other embodiments may be used and structural and operational changes may be made without departure from the scope of the present disclosure.

The presently disclosed embodiments are directed generally to an improved electrostatographic imaging member having a specific mixture of high mobility transport molecules that provide enhanced charge transport across the charge transport layer (CTL) but without the problems common to conventional transport molecules such as triphenyl amine, N,N,N′,N′-tetra-p-tolyl-1,1′-biphenyl-4,4′-diamine (TM-TPD). The imaging members having a CTL comprising this mixture have shown to provide good or improved electrical performance with substantially less crystallization than imaging members having a conventional CTL with only TM-TPD.

In a typical electrostatographic reproducing or digital printing apparatus using a photoreceptor, a light image is recorded in the form of an electrostatic latent image upon a photosensitive member and the latent image is subsequently rendered visible by the application of a developer mixture. The developer, having toner particles contained therein, is brought into contact with the electrostatic latent image to develop the image on an electrostatographic imaging member which has a charge-retentive surface. The developed toner image can then be transferred to a copy substrate, such as paper, that receives the image via a transfer member.

The exemplary embodiments of this disclosure are described below with reference to the drawings. The specific terms are used in the following description for clarity, selected for illustration in the drawings and not to define or limit the scope of the disclosure. The same reference numerals are used to identify the same structure in different figures unless specified otherwise. The structures in the figures are not drawn according to their relative proportions and the drawings should not be interpreted as limiting the disclosure in size, relative size, or location. In addition, though the discussion will address negatively charged systems, the imaging members of the present disclosure may also be used in positively charged systems.

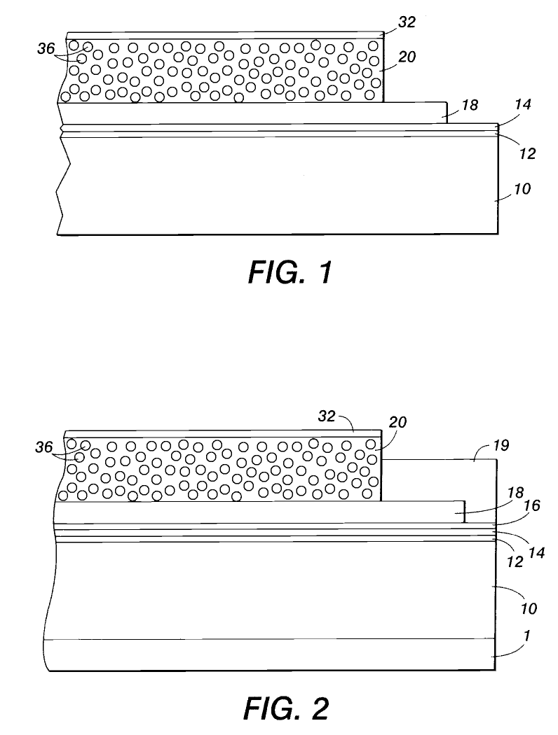

FIG. 1 is an exemplary embodiment of a multilayered electrophotographic imaging member having a drum configuration. As can be seen, the exemplary imaging member includes a rigid support substrate 10, an undercoat layer 14, a charge generation layer 18 and a charge transport layer 20. The rigid substrate may be comprised of a material selected from the group consisting of a metal, metal alloy, aluminum, zirconium, niobium, tantalum, vanadium, hafnium, titanium, nickel, stainless steel, chromium, tungsten, molybdenum, and mixtures thereof. The charge generation layer 18 and the charge transport layer 20 forms an imaging layer described here as two separate layers. In an alternative to what is shown in the figure, the charge generation layer may also be disposed on top of the charge transport layer. It will be appreciated that the functional components of these layers may alternatively be combined into a single layer.

The Overcoat Layer

Other layers of the imaging member may include, for example, an optional over coat layer 32. An optional overcoat layer 32, if desired, may be disposed over the charge transport layer 20 to provide imaging member surface protection as well as improve resistance to abrasion. In embodiments, the overcoat layer 32 may have a thickness ranging from about 0.1 micrometer to about 10 micrometers or from about 1 micrometer to about 10 micrometers, or in a specific embodiment, about 3 micrometers. These overcoating layers may include thermoplastic organic polymers or inorganic polymers that are electrically insulating or slightly semi-conductive. For example, overcoat layers may be fabricated from a dispersion including a particulate additive in a resin. Suitable particulate additives for overcoat layers include metal oxides including aluminum oxide, non-metal oxides including silica or low surface energy polytetrafluoroethylene (PTFE), and combinations thereof. Suitable resins include those described above as suitable for photogenerating layers and/or charge transport layers, for example, polyvinyl acetates, polyvinylbutyrals, polyvinylchlorides, vinylchloride and vinyl acetate copolymers, carboxyl-modified vinyl chloride/vinyl acetate copolymers, hydroxyl-modified vinyl chloride/vinyl acetate copolymers, carboxyl- and hydroxyl-modified vinyl chloride/vinyl acetate copolymers, polyvinyl alcohols, polycarbonates, polyesters, polyurethanes, polystyrenes, polybutadienes, polysulfones, polyarylethers, polyarylsulfones, polyethersulfones, polyethylenes, polypropylenes, polymethylpentenes, polyphenylene sulfides, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, poly-N-vinylpyrrolidinones, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazoles, and combinations thereof. Overcoating layers may be continuous and have a thickness from about 0.5 micrometer to about 10 micrometers, in embodiments from about 2 micrometers to about 6 micrometers.

The Substrate

The photoreceptor support substrate 10 may be opaque or substantially transparent, and may comprise any suitable organic or inorganic material having the requisite mechanical properties. The entire substrate can comprise the same material as that in the electrically conductive surface, or the electrically conductive surface can be merely a coating on the substrate. Any suitable electrically conductive material can be employed, such as for example, metal or metal alloy. Typical electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hafnium, titanium, nickel, niobium, stainless steel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be single metallic compound or dual layers of different metals and/or oxides.

The substrate 10 can also be formulated entirely of an electrically conductive material, or it can be an insulating material including inorganic or organic polymeric materials, such as MYLAR, a commercially available biaxially oriented polyethylene terephthalate from DuPont, or polyethylene naphthalate available as KALEDEX 2000, with a ground plane layer 12 comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support substrate depends on numerous factors, including mechanical performance and economic considerations.

The substrate 10 may have a number of many different configurations, such as for example, a plate, a cylinder, a drum, a scroll, an endless flexible belt, and the like. In the case of the substrate being in the form of a belt, as shown in FIG. 2, the belt can be seamed or seamless. In embodiments, the photoreceptor herein is in a drum configuration.

The thickness of the substrate 10 depends on numerous factors, including flexibility, mechanical performance, and economic considerations. The thickness of the support substrate 10 of the present embodiments may range from about 500 micrometers to about 3,000 micrometers, or from about 750 micrometers to about 2500 micrometers.

An exemplary substrate support 10 is not soluble in any of the solvents used in each coating layer solution, is optically transparent or semi-transparent, and is thermally stable up to a high temperature of about 150° C. A typical substrate support 10 used for imaging member fabrication has a thermal contraction coefficient ranging from about 1×10⁻⁵ per ° C. to about 3×10⁻⁵ per ° C. and a Young's Modulus of between about 5×10⁻⁵ psi (3.5×10⁻⁴ Kg/cm²) and about 7×10⁻⁵ psi (4.9×10⁴ Kg/cm²).

The Ground Plane

The electrically conductive ground plane 12 may be an electrically conductive metal layer which may be formed, for example, on the substrate 10 by any suitable coating technique, such as a vacuum depositing technique. Typical metals include aluminum, zirconium, niobium, tantalum, vanadium, hafnium, titanium, nickel, stainless steel, chromium, tungsten, molybdenum, and other conductive substances, and mixtures thereof. The conductive layer may vary in thickness over substantially wide ranges depending on the optical transparency and flexibility desired for the electrophotoconductive member. Accordingly, for a flexible photoresponsive imaging device, the thickness of the conductive layer may be between about 20 Angstroms to about 750 Angstroms, and more preferably from about 50 Angstroms to about 200 Angstroms for an optimum combination of electrical conductivity, flexibility and light transmission.

Regardless of the technique employed to form the metal layer, a thin layer of metal oxide forms on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as transparent layer for light having a wavelength between about 4000 Angstroms and about 9000 Angstroms or a conductive carbon black dispersed in a polymeric binder as an opaque conductive layer.

The Hole Blocking Layer

After deposition of the electrically conductive ground plane layer, the hole blocking layer 14 may be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer may be utilized. The hole blocking layer may include polymers such as polyvinylbutryral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl)gamma-amino-propyl trimethoxy silane, isopropyl 4-aminobenzene sulfonyl, di(dodecylbenzene sulfonyl)titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl)methyl diethoxysilane, and [H₂N(CH₂)₃]CH₃Si(OCH₃)₂ (gamma-aminopropyl)methyl diethoxysilane, as disclosed in U.S. Pat. Nos. 4,338,387, 4,286,033 and 4,291,110.

General embodiments of the undercoat layer may comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Typical undercoat layer binder materials include, for example, polyesters, MOR-ESTER 49,000 from Morton International Inc., VITEL PE-100, VITEL PE-200, VITEL PE-200D, and VITEL PE-222 from Goodyear Tire and Rubber Co., polyarylates such as ARDEL from AMOCO Production Products, polysulfone from AMOCO Production Products, polyurethanes, and the like.

The hole blocking layer should be continuous and have a thickness of less than about 0.5 micrometer because greater thicknesses may lead to undesirably high residual voltage. A hole blocking layer of between about 0.005 micrometer and about 0.3 micrometer is preferred because charge neutralization after the exposure step is facilitated and optimum electrical performance is achieved. A thickness of between about 0.03 micrometer and about 0.06 micrometer is preferred for hole blocking layers for optimum electrical behavior. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer is preferably applied in the form of a dilute solution, with the solvent being removed after deposition of the coating by conventional techniques such as by vacuum, heating and the like. Generally, a weight ratio of hole blocking layer material and solvent of between about 0.05:100 to about 0.5:100 is satisfactory for spray coating.

The Charge Generation Layer

The charge generation layer 18 may thereafter be applied to the undercoat layer 14. Any suitable charge generation binder including a charge generating/photoconductive material, which may be in the form of particles and dispersed in a film forming binder, such as an inactive resin, may be utilized. Examples of charge generating materials include, for example, inorganic photoconductive materials such as amorphous selenium, trigonal selenium, and selenium alloys selected from the group consisting of selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference. Multi-charge generation layer compositions may be used where a photoconductive layer enhances or reduces the properties of the charge generation layer. Other suitable charge generating materials known in the art may also be utilized, if desired. The charge generating materials selected should be sensitive to activating radiation having a wavelength between about 400 and about 900 nm during the imagewise radiation exposure step in an electrophotographic imaging process to form an electrostatic latent image. For example, hydroxygallium phthalocyanine absorbs light of a wavelength of from about 370 to about 950 nanometers, as disclosed, for example, in U.S. Pat. No. 5,756,245.

Any suitable inactive resin materials may be employed as a binder in the charge generation layer 18, including those described, for example, in U.S. Pat. No. 3,121,006, the entire disclosure thereof being incorporated herein by reference. Typical organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

The charge generating material can be present in the resinous binder composition in various amounts. Generally, from about 5 percent by volume to about 90 percent by volume of the charge generating material is dispersed in about 95 percent by volume to about 10 percent by volume of the resinous binder, and more specifically from about 20 percent by volume to about 60 percent by volume of the charge generating material is dispersed in about 80 percent by volume to about 40 percent by volume of the resinous binder composition.

In specific embodiments, the charge generation layer 18 may have a thickness ranging from about 0.1 μm to about 2 μm, or from about 0.2 μm to about 1 μm. These embodiments may be comprised of chlorogallium phthalocyanine or hydroxygallium phthalocyanine or mixtures thereof. The charge generation layer 18 containing the charge generating material and the resinous binder material generally ranges in thickness of from about 0.1 μm to about 5 μm, for example, from about 0.2 μm to about 3 μm when dry. The charge generation layer thickness is generally related to binder content. Higher binder content compositions generally employ thicker layers for charge generation.

The Charge Transport Layer

In a drum photoreceptor, the charge transport layer comprises a single layer of the same composition. As such, the charge transport layer will be discussed specifically in terms of a single layer 20, but the details will be also applicable to an embodiment having dual charge transport layers. The charge transport layer 20 is thereafter applied over the charge generation layer 18 and may include any suitable transparent organic polymer or non-polymeric material capable of supporting the injection of photogenerated holes or electrons from the charge generation layer 18 and capable of allowing the transport of these holes/electrons through the charge transport layer to selectively discharge the surface charge on the imaging member surface. In one embodiment, the charge transport layer 20 not only serves to transport holes, but also protects the charge generation layer 18 from abrasion or chemical attack and may therefore extend the service life of the imaging member. The charge transport layer 20 can be a substantially non-photoconductive material, but one which supports the injection of photogenerated holes from the charge generation layer 18.

The layer 20 is normally transparent in a wavelength region in which the electrophotographic imaging member is to be used when exposure is affected there to ensure that most of the incident radiation is utilized by the underlying charge generation layer 18. The charge transport layer should exhibit excellent optical transparency with negligible light absorption and no charge generation when exposed to a wavelength of light useful in xerography, e.g., 400 to 900 nanometers. In the case when the photoreceptor is prepared with the use of a transparent substrate 10 and also a transparent or partially transparent conductive layer 12, image wise exposure or erase may be accomplished through the substrate 10 with all light passing through the back side of the substrate. In this case, the materials of the layer 20 need not transmit light in the wavelength region of use if the charge generation layer 18 is sandwiched between the substrate and the charge transport layer 20. The charge transport layer 20 in conjunction with the charge generation layer 18 is an insulator to the extent that an electrostatic charge placed on the charge transport layer is not conducted in the absence of illumination. The charge transport layer 20 should trap minimal charges as the charge passes through it during the discharging process.

The charge transport layer 20 may include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes through. This addition converts the electrically inactive polymeric material to a material capable of supporting the injection of photogenerated holes from the charge generation layer 18 and capable of allowing the transport of these holes through the charge transport layer 20 in order to discharge the surface charge on the charge transport layer. The high mobility charge transport component typically comprises small molecules of an organic compound which cooperate to transport charge between molecules and ultimately to the surface of the charge transport layer. For example, but not limited to, N,N′-diphenyl-N,N-bis(3-methyl phenyl)-1,1′-biphenyl-4,4′-diamine (TPD), other arylamines like triphenyl amine, N,N,N′,N′-tetra-p-tolyl-1,1′-biphenyl-4,4′-diamine (TM-TPD), and the like.

In specific embodiments, the charge transport layer 20 includes a transport molecule mixture 36 of p-MeOTPD or p-TPD or the like with TM-TPD which has shown to maintain or improve electrical performance in photoreceptors but with substantially less crystallization that is associated with use of TM-TPD alone. Higher boiling solvents and slow dry time necessary for drum coating facilitates crystallization of the TM-TPD molecule in the CTL after drum coating. This crystallization limits the usefulness of TM-TPD in drum applications. The propensity for crystallization in solution especially at increased concentrations limits the usefulness in both drum and web applications making the solutions costly alternatives due to the short pot-life.

It was discovered that, by mixing TM-TPD, as a first charge transport molecule, with another second transport molecule, such as p-MeOTPD, p-TPD,

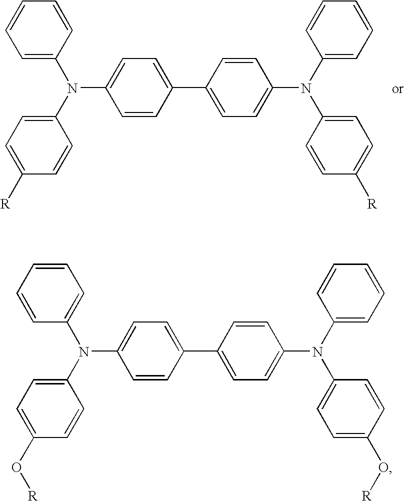

wherein R is an alkyl isomer, or the like, crystallization was substantially avoided. For example, as shown in more detail in the Examples, charge transport layer formulations were coated onto drums already prepared with standard charge generation and undercoat layers. Crystallization occurred in 100% of the TM-TPD controls and in those where the CTL formulation was doped with either p-TPD or p-MeOTPD at 4 percent by weight. However, tested samples with higher levels of p-TPD or p-MeOTPD did not exhibit any crystallization. For example, those tested samples having p-TPD or p-MeOTPD in the CTL coating from about 5 percent to about 40 percent, or from about 10 percent to about 35 percent by weight, did not exhibit crystallization. In embodiments, a ratio of the first transport molecule to the second transport molecule is the same in the charge transport layer. In further embodiments, the ratio of the first transport molecule to the second transport molecule can be different in the charge transport layer.

The results demonstrated that incorporation into the CTL coating of these specific transport molecule mixtures of p-TPD or p-MeOTPD with TM-TPD provide a high mobility charge transport layer with substantially less crystallization while providing good electrical performance. The specific mixture 36 impedes crystallization in solution as well as during the coating/drying process of the CTL in drum configuration. Use of the specific mixture 36 may also prevent microcrystallization at the interface of transport layer 20 and overcoat layer 32.

Examples of the binder materials selected for the charge transport layers include components, such as those described in U.S. Pat. No. 3,121,006, the disclosure of which is totally incorporated herein by reference. Specific examples of polymer binder materials include polycarbonates, polyarylates, acrylate polymers, vinyl polymers, cellulose polymers, polyesters, polysiloxanes, polyamides, polyurethanes, poly(cyclo olefins), and epoxies, and random or alternating copolymers thereof. In embodiments, the charge transport layer, such as a hole transport layer, may have a thickness from about 10 μm to about 40 μm.

Examples of components or materials optionally incorporated into the charge transport layers or at least one charge transport layer to, for example, enable improved lateral charge migration (LCM) resistance include hindered phenolic antioxidants such as tetrakis methylene(3,5-di-tert-butyl-4-hydroxyhydrocinnamate)methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd.), TINUVIN® 144 and 622LD (available from Ciba Specialties Chemicals), MARK™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layer is from about 0 to about 20, from about 1 to about 10, or from about 3 to about 8 weight percent.

The charge transport layer should be an insulator to the extent that the electrostatic charge placed on the hole transport layer is not conducted in the absence of illumination at a rate sufficient to prevent formation and retention of an electrostatic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

Any suitable and conventional technique may be utilized to form and thereafter apply the charge transport layer mixture to the supporting substrate layer. The charge transport layer may be formed in a single coating step or in multiple coating steps. Dip coating, ring coating, spray, gravure or any other drum coating methods may be used.

Drying of the deposited coating may be effected by any suitable conventional technique such as oven drying, infra red radiation drying, air drying and the like. The thickness of the charge transport layer after drying is from about 10 μm to about 40 μm or from about 12 μm to about 36 μm for optimum photoelectrical and mechanical results. In another embodiment the thickness is from about 14 μm to about 36 μm.

FIG. 2 shows an imaging member having a belt configuration according to the embodiments. As shown, the belt configuration is provided with an anti-curl back coating 1, a supporting substrate 10, an electrically conductive ground plane 12, an undercoat layer 14, an adhesive layer 16, a charge generating layer 18, and a charge transport layer 20. An optional overcoat layer 32 and ground strip 19 may also be included. An exemplary photoreceptor having a belt configuration is disclosed in U.S. Pat. No. 5,069,993, which is hereby incorporated by reference.

The Adhesive Layer

An optional separate adhesive interface layer may be provided in certain configurations, such as for example, in flexible web configurations. In the embodiment illustrated in FIG. 1, the interface layer would be situated between the blocking layer 14 and the charge generation layer 18. The interface layer may include a copolyester resin. Exemplary polyester resins which may be utilized for the interface layer include polyarylatepolyvinylbutyrals, such as ARDEL POLYARYLATE (U-100) commercially available from Toyota Hsutsu Inc., VITEL PE-100, VITEL PE-200, VITEL PE-200D, and VITEL PE-222, all from Bostik, 49,000 polyester from Rohm Hass, polyvinyl butyral, and the like. The adhesive interface layer may be applied directly to the hole blocking layer 14. Thus, the adhesive interface layer in embodiments is in direct contiguous contact with both the underlying hole blocking layer 14 and the overlying charge generator layer 18 to enhance adhesion bonding to provide linkage. In yet other embodiments, the adhesive interface layer is entirely omitted.

Any suitable solvent or solvent mixtures may be employed to form a coating solution of the polyester for the adhesive interface layer. Typical solvents include tetrahydrofuran, toluene, monochlorbenzene, methylene chloride, cyclohexanone, and the like, and mixtures thereof. Any other suitable and conventional technique may be used to mix and thereafter apply the adhesive layer coating mixture to the hole blocking layer. Typical application techniques include spraying, dip coating, roll coating, wire wound rod coating, and the like. Drying of the deposited wet coating may be effected by any suitable conventional process, such as oven drying, infra red radiation drying, air drying, and the like.

The adhesive interface layer may have a thickness of from about 0.01 micrometers to about 900 micrometers after drying. In embodiments, the dried thickness is from about 0.03 micrometers to about 1 micrometer.

The Ground Strip

The ground strip may comprise a film forming polymer binder and electrically conductive particles. Any suitable electrically conductive particles may be used in the electrically conductive ground strip layer 19. The ground strip 19 may comprise materials which include those enumerated in U.S. Pat. No. 4,664,995. Typical electrically conductive particles include carbon black, graphite, copper, silver, gold, nickel, tantalum, chromium, zirconium, vanadium, niobium, indium tin oxide and the like. The electrically conductive particles may have any suitable shape. Typical shapes include irregular, granular, spherical, elliptical, cubic, flake, filament, and the like. Preferably, the electrically conductive particles should have a particle size less than the thickness of the electrically conductive ground strip layer to avoid an electrically conductive ground strip layer having an excessively irregular outer surface. An average particle size of less than about 10 micrometers generally avoids excessive protrusion of the electrically conductive particles at the outer surface of the dried ground strip layer and ensures relatively uniform dispersion of the particles throughout the matrix of the dried ground strip layer. The concentration of the conductive particles to be used in the ground strip depends on factors such as the conductivity of the specific conductive particles utilized.

The ground strip layer may have a thickness from about 7 micrometers to about 42 micrometers, and preferably from about 14 micrometers to about 27 micrometers.

The Anti-Curl Back Coating Layer

The anti-curl back coating 1 may comprise organic polymers or inorganic polymers that are electrically insulating or slightly semi-conductive. The anti-curl back coating provides flatness and/or abrasion resistance.

Anti-curl back coating 1 may be formed at the back side of the substrate 2, opposite to the imaging layers. The anti-curl back coating may comprise a film forming resin binder and an adhesion promoter additive. The resin binder may be the same resins as the resin binders of the charge transport layer discussed above. Examples of film forming resins include polyacrylate, polystyrene, bisphenol polycarbonate, poly(4,4′-isopropylidene diphenyl carbonate), 4,4′-cyclohexylidene diphenyl polycarbonate, and the like. Typical adhesion promoters used as additives include 49,000 (du Pont), Vitel PE-100, Vitel PE-200, Vitel PE-307 (Goodyear), and the like. Usually from about 1 to about 15 weight percent adhesion promoter is selected for film forming resin addition. The thickness of the anti-curl back coating is from about 3 micrometers to about 35 micrometers, and preferably about 14 micrometers.

As with the drum configuration, incorporation of the specific mixture of transport molecules 36, p-TPD, p-MeOTPD, or the like, with TM-TPD into the CTL coating for an imaging member having a belt configuration prevents crystallization.

It was demonstrated, as shown in more detail in the Examples, that tested samples having p-TPD or p-MeOTPD in the CTL coating suspension did not exhibit crystallization in the dried films. These CTL coating suspensions had from about 4 percent to about 35 percent, or from about 8 percent to about 25 percent by weight, of p-TPD or p-MeOTPD.

Thus, the results demonstrated that use of these specific transport molecule mixtures of p-TPD or p-MeOTPD with TM-TPD provide a high mobility charge transport layer with substantially less crystallization and good electrical performance in imaging members having both belt configurations and drum configurations.

In addition, in the present embodiments using a belt configuration, the charge transport layer may consist of a single pass charge transport layer or a dual pass charge transport layer (or dual layer charge transport layer) with the same or different transport molecule ratios. In these embodiments, the dual layer charge transport layer has a total thickness of from about 10 μm to about 40 μm. In other embodiments, each layer of the dual layer charge transport layer may have an individual thickness of from 2 μm to about 20 μm. Moreover, the charge transport layer may be configured such that it is used as a top layer of the photoreceptor to inhibit crystallization at the interface of the charge transport layer and the overcoat layer. In another embodiment, the charge transport layer may be configured such that it is used as a first pass charge transport layer to inhibit microcrystallization occurring at the interface between the first pass and second pass layers.

Various exemplary embodiments encompassed herein include a method of imaging which includes generating an electrostatic latent image on an imaging member, developing a latent image, and transferring the developed electrostatic image to a suitable substrate.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Example 1

An undercoat layer comprised of g-Aminopropyltriethoxysilane, tributoxyzirconiumacetylacetonate, and polyvinylbutyral is prepared and formed directly over the substrate of the photoreceptor drum. The resulting dried undercoat layer has a thickness of from about 0.5 μm to about 3 μm. A charge generating layer comprising hydroxygallium phthalocyanine and poly(vinyl chloride/vinyl acetate) resin (e.g., VMCH available from Union Carbide) is formed over the undercoat layer. A charge transport layer having a thickness of from about 12 μm to about 36 μm is formed over the charge generating layer of the photoreceptor drum.

A base stock of transport layer solution is prepared with 14.25 weight percent plycarbonate binder, for example PCZ-400 (M_{w}=40,000), about 1 percent by weight antioxidant, from about 2 to about 15% PTFE particles (including surfactant to disperse the PTFE) in a solvent mixture of tetrahydrofuran and toluene.

Mixtures of high mobility transport molecules were added to the base PTFE/binder CT solution to form a charge transport layer. Transport layers were coated onto drums using a dip coating process and dried to form the fully coated device with transport layer thickness of about 30micrometers. Crystallization occurred in 100% TM-TPD controls and in samples doped with either p-TPD or p-MeOTPD (doped at less than 7wt %). Samples with higher levels of p-TPD or p-MeOTPD did not show any evidence of crystallization.

Samples without crystallization were electrically tested and showed good PIDC characteristics, low dark decay, and low Vᵣ (Table 1). Note that V_{low} at 1.4 erg remains unchanged in the mixtures and is well below the 1.4 erg value obtained with the control TPD doped transport layer, demonstrating the increased mobility of the transport layers prepared with the TM-TPD. The erase voltage (Vₑᵣₐₛₑ) is much lower than the control sample indicating efficient movement of charge out of the drum photoreceptor. As the samples with 100% TM-TPD crystallized, TPD was used as a known standard transport molecule for comparison and to insure the other layers were performing as expected.

TABLE 1

| | | Thickness | | V | | Dark |
|---|---|---|---|---|---|---|
| Sample | Mixture | (μm) | V (0) | (1.4) | Vₑᵣₐₛₑ | Decay |
| 1 | 32% TM-TPD + | 26.9 | 704 | 217 | 9 | 12 |
| | 11% p-TPD | | | | | |
| 2 | 21.5% TM-TPD + | 26.5 | 703 | 221 | 10 | 11 |
| | 21.5% p-TPD | | | | | |
| 3 | 32% TM-TPD + | 26.7 | 705 | 229 | 9 | 9 |
| | 11% p-MeOTPD | | | | | |
| 4 | 21.5% TM-TPD + | 26.3 | 701 | 234 | 10 | 10 |
| | 21.5% p-MeOTPD | | | | | |
| Control | 43% TPD | 26.9 | 706 | 254 | 26 | 9 |

A conductive gold electrode was evaporated on the surface of the photoreceptors to provide a conductive contact. The samples were then electroded and electrically exercised by inducing 30K charge-expose-erase cycles at lab ambient environment of about 70 F, 40% RH. The samples showed excellent cyclic stability with no evidence in cycle up or cycle down in either Vhigh or Verase indicating efficient movement of charge out of the device

In further embodiments, charge transport molecule combinations with TM-TPD to include p-MeOTPD, pTPD and the like can include any combination/ratio of materials.

### Example 2

An imaging member was prepared by providing a 0.02 micrometer thick titanium layer coated on a biaxially oriented polyethylene naphthalate substrate (KALEDEX™ 2000) having a thickness of 3.5 mils, and applying thereon, with a gravure applicator, a solution containing 50 grams 3-amino-propyltriethoxysilane, 41.2 grams water, 15 grams acetic acid, 684.8 grams of 200 proof denatured alcohol and 200 grams heptane. This layer was then dried for about 5 minutes at 135° C. in the forced air drier of the coater. The resulting blocking layer (14) had a dry thickness of 500 Angstroms.

An adhesive layer (16) was then prepared by applying a wet coating over the blocking layer, using a gravure applicator, containing 0.2 percent by weight based on the total weight of the solution of copolyester adhesive (Ardel D100 available from Toyota Hsutsu Inc.) in a 60:30:10 volume ratio mixture of tetrahydrofuran/monochlorobenzene/methylene chloride. The adhesive layer was then dried for about 5 minutes at 135° C. in the forced air dryer of the coater. The resulting adhesive layer had a dry thickness of 200 Angstroms.

A photogenerating layer dispersion is prepared by introducing 0.45 grams of lupilon200 (PC-Z 200) available from Mitsubishi Gas Chemical Corp and 50 ml of tetrahydrofuran into a 4 oz. glass bottle. To this solution are added 2.4 grams of hydroxygallium phthalocyanine and 300 grams of ⅛ inch (3.2 millimeter) diameter stainless steel shot. This mixture is then placed on a ball mill for 20 to 24 hours. Subsequently, 2.25 grams of PC-Z 200 is dissolved in 46.1 gm of tetrahydrofuran, and added to this OHGaPc slurry. This slurry is then placed on a shaker for 10 minutes. The resulting slurry was, thereafter, applied to the adhesive interface with a Bird applicator to form a charge generation layer (18) having a wet thickness of 0.25 mil. However, a strip about 10 mm wide along one edge of the substrate web bearing the blocking layer and the adhesive layer was deliberately left uncoated by any of the photogenerating layer material to facilitate adequate electrical contact by the ground strip layer that was applied later. The charge generation layer was dried at 135° C. for 5 minutes in a forced air oven to form a dry charge generation layer having a thickness of 0.4 micrometer. The films were subsequently coated with the charge transport layers described below.

Charge transport layers were prepared with varying mixtures of TM-TPD and p-TPD or p-MeOTPD were prepared using a base stock transport layer solution comprised of 12.5 percent by weight of Makrolon 5705, a polycarbonate resin having a molecular weight of from about 50,000 to 100,000 commercially available from Farbenfabriken Bayer A.G. and fully dried. Key PIDC metrics from the transport molecule mixture series of TM-TPD with p-TPD or p-MeOTPD are shown in Table 2 below. Note that V_{low} at 2.1 erg is maintained for the mixtures with p-MeOTPD and that the erase voltage (Vₑᵣₐₛₑ) remains consistent with the control sample indicating efficient movement of charge out of the belt photoreceptor. In the mixtures with p-TPD, there is some increase in V_{low}, Vₑᵣₐₛₑ and dark decay rate, indicating the presence of some slower moving carriers.

TABLE 2

| | | Thickness | | | Dark |
|---|---|---|---|---|---|
| Sample | Mixture | (μm) | V (2.1) | Vₑᵣₐₛₑ | Decay |
| Control | 50% TM-TPD | 22.4 | 36.2 | 6.3 | 22.2 |
| 1 | 40% TM-TPD + | 20.8 | 69.6 | 28.3 | 27.6 |
| | 10% p-TPD | | | | |
| 2 | 35% TM-TPD + | 21.3 | 81.4 | 35.5 | 26.4 |
| | 15% p-TPD | | | | |
| 3 | 30% TM-TPD + | 21.7 | 76.1 | 34.5 | 26.9 |
| | 20% p-TPD | | | | |
| 4 | 25% TM-TPD + | 22.1 | 86.2 | 43.6 | 23.8 |
| | 25% p-TPD | | | | |
| 5 | 40% TM-TPD + | 21.7 | 40.6 | 6.9 | 19.7 |
| | 10% p-MeOTPD | | | | |
| 6 | 35% TM-TPD + | 21.3 | 45.8 | 7.9 | 22.5 |
| | 15% p-MeOTPD | | | | |
| 7 | 30% TM-TPD + | 20.9 | 44.0 | 6.9 | 22.7 |
| | 20% p-MeOTPD | | | | |
| 8 | 25% TM-TPD + | 20.4 | 53.9 | 7.1 | 22.5 |
| | 25% p-MeOTPD | | | | |

In further embodiments, charge transport molecule combinations with TM-TPD to include p-MeOTPD, PTPD and the like can include any combination/ratio of materials.

All the patents and applications referred to herein are hereby specifically, and totally incorporated herein by reference in their entirety in the instant specification.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An imaging member comprising:
a substrate;
an undercoat layer disposed on the substrate;
a charge generation layer disposed on the undercoat layer, wherein the charge generation layer comprises a phthalocyanine pigment;
a charge transport layer disposed on the charge generation layer, wherein the charge transport layer comprises a first transport molecule and a second transport molecule, the first transport molecule being 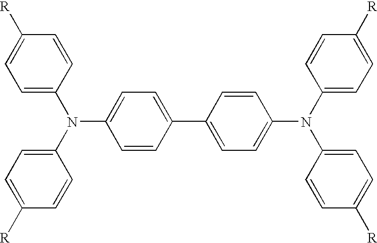
wherein R is an alkyl isomer, and the second transport molecule being selected from the group consisting of 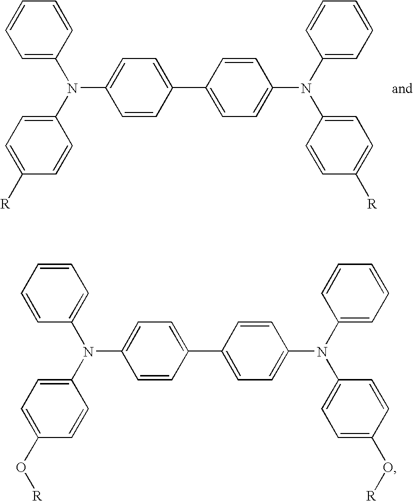
wherein R is an alkyl isomer; and
an optional overcoat layer.

2. The imaging member of claim 1, wherein the alkyl isomer is selected from the group consisting of ethyl isomer, methyl isomer, propyl isomer, butyl isomer, and mixtures thereof.

3. The imaging member of claim 1, wherein the charge transport layer has a thickness of from about 10 μm to about 40 μm.

4. The imaging member of claim 1, wherein the substrate is in a drum configuration.

5. The imaging member of claim 4, wherein the second transport molecule is present in the charge transport layer in an amount of from about 5 percent to about 30 percent by weight.

6. The imaging member of claim 5, wherein the second transport molecule is present in the charge transport layer in an amount of from about 10 percent to about 25 percent by weight.

7. The imaging member of claim 1, wherein the substrate is in a flexible belt configuration.

8. The imaging member of claim 7 further including an anticurl back coating disposed on the substrate on a side opposite to the undercoat layer.

9. The imaging member of claim 7, wherein the second transport molecule is present in the charge transport layer in an amount of from about 5 percent to about 30 percent by weight.

10. The imaging member of claim 9, wherein the second transport molecule is present in the charge transport layer in an amount of from about 10 percent to about 25 percent by weight.

11. The imaging member of claim 1, wherein a ratio of the first transport molecule to the second transport molecule is the same in the charge transport layer.

12. The imaging member of claim 1, wherein a ratio of the first transport molecule to the second transport molecule is different in the charge transport layer.

13. An imaging member comprising:
a substrate;
an undercoat layer disposed on the substrate;
a charge generation layer disposed on the undercoat layer, wherein the charge generation layer comprises a phthalocyanine pigment;
a dual layer charge transport layer disposed on the charge generation layer, wherein the dual layer charge transport layer comprises a first transport molecule and a second transport molecule, the first transport molecule being TM-TPD and the second transport molecule being selected from the group consisting of p-TPD, p-MeOTPD, 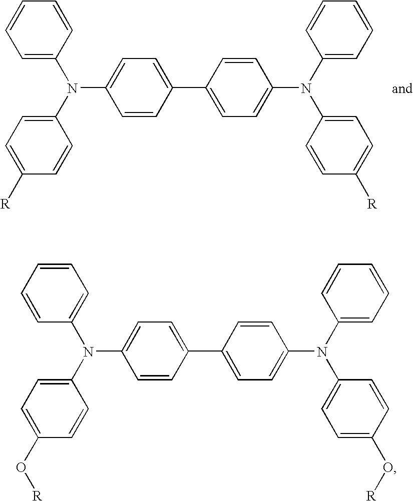
wherein R is an alkyl isomer; and
an optional overcoat layer.

14. The imaging member of claim 13, wherein a ratio of the first transport molecule to the second transport molecule is the same in the dual layers of the dual layer charge transport layer.

15. The imaging member of claim 13, wherein a ratio of the first transport molecule to the second transport molecule is different in the dual layers of the dual layer charge transport layer.

16. The imaging member of claim 13, wherein the second transport molecule is present in the dual charge transport layer in an amount of from about 10 percent to about 25 percent by weight.

17. The imaging member of claim 16, wherein the second transport molecule is present in the dual charge transport layer in an amount of from about 15 percent to about 20 percent by weight.

18. The imaging member of claim 13, wherein the dual layer charge transport layer has a total thickness of from about 10 μm to about 40 μm.

19. An imaging member comprising:
a substrate;
an undercoat layer disposed on the substrate;
a charge generation layer disposed on the undercoat layer, wherein the charge generation layer comprises a phthalocyanine pigment;
a charge transport layer disposed on the charge generation layer, wherein the charge transport layer comprises a first transport molecule and a second transport molecule, the first transport molecule being TM-TPD and the second transport molecule being p-TPD or p-MeOTPD; and
an optional overcoat layer.

20. The imaging member of claim 19, wherein the substrate has a configuration selected from the group consisting of a plate, a cylinder, a drum, a scroll, and an endless flexible belt.
